(19) United States
(12) Patent Application Publication
(10) Pub. No.: US 2009/0091922 A1
(43) Pub. Date: Apr. 9, 2009

(54) Decorative object connectable to a connected object

(76) Inventor: Jung-Chou Yang, Taiping City (TW)

Correspondence Address: TROXELL LAW OFFICE PLLC, SUITE 1404, 5205 LEESBURG PIKE, FALLS CHURCH, VA, 22041, US

(21) Appl. No.: 12/071,062

(22) Filed: Feb. 14, 2008

Related U.S. Application Data
(63) Continuation-in-part of application No. 11/905,875, filed on Oct. 5, 2007.

(51) Int. Cl. F21V 21/08

(52) U.S. Cl. 362/103

(57) ABSTRACT

In a decorative object connectable to a connected object, the decorative object includes a connecting member having a fixing portion at an end of the connecting member, and the fixing portion is connected and fixed to a stylish decorative object with a specific shape, and another end of the connecting member is a positioning portion, and a passage is penetrated through the positioning portion and provided for passing and fixing the connected object, and the stylish decorative object includes a light emitting element.

This is a Continuation-In-Part application of applicant's former patent application with application Ser. No. 11/905,875.

### BACKGROUND OF THE INVENTION

1. Field of the Invention

The present invention relates to a decorative object connectable to a connected object, and more particularly to a decorative object that can be installed and removed at the connected object.

2. Description of the Related Art

In general, a traditional decorative object installed on a connected object such as a shoe, a hat, a backpack, or a cloth is fixed. Although these decorative objects can provide the decorating effect, they also have the following problems:

1. The decorative object cannot be replaced. Most of the traditional decorative objects installed on a connected object are fixed, and thus they cannot be replaced. For users who want to have new configurations from time to time, the decorative object cannot meet the requirement for such a change of connected object.

2. The decorative object does not provide any warning. In general, the decorative object installed on a connected object is used for decoration only, and usually does not have any lighting effect, and thus the decorative objects of this sort will not provide any warning when users are walking at nighttime.

3. The decorative object does not have much fun. Since the traditional decorative object cannot be replaced, and does not come with a lighting effect, therefore its use is relatively monotonous.

### SUMMARY OF THE INVENTION

It is a primary objective of the present invention to overcome the aforementioned shortcoming by connecting a stylish decorative object and a connecting member, wherein a passage of a fixing portion of the connecting member is provided to facilitate the installation and removal of the decorative object on the connected object (in the form of a string or a strap), so that the stylish decorative object can be installed easily and securely onto the connected object for the decoration purpose.

Another objective of the present invention is to use the fixing portion of the connecting member to install a light emitting element and connect the stylish decorative object, not only improving the decoration effect of the stylish decorative object, but also providing a warning effect for users to walk at nighttime.

A further objective of the present invention is to provide a slot disposed on a lateral side of the fixing portion for directly stuffing the connected object (in the form of a string) into the passage from the slot to install or remove the decorative object on the connected object.

Another further objective of the present invention is to install a decorative object easily onto a connected object without the risk of falling off due to vibrations, since the slot, the connecting member and the stylish decorative object are not aligned linearly with each other, but they are installed towards a lateral side.

### BRIEF DESCRIPTION OF THE DRAWINGS

FIG. 1 is a perspective view of the present invention;

FIG. 2 is an exploded view of the present invention;

FIG. 3 is a sectional view of the present invention;

FIG. 4 is a perspective view of another stylish decorative object of the present invention;

FIG. 5 is a schematic view of a decorative object combined with a shoe lace of a shoe in accordance with the present invention;

FIG. 6 is a sectional view of a decorative object combined with a shoe lace of a shoe in accordance with the present invention;

FIG. 7 is a perspective view of a decorative object in accordance with a second preferred embodiment of the present invention;

FIG. 8 is a sectional view of a structure in accordance with a second preferred embodiment of the present invention; and

FIG. 9 is sectional view of a decorative object combined with a backpack in accordance with a second preferred embodiment of the present invention.

### DETAILED DESCRIPTION OF THE PREFERRED EMBODIMENTS

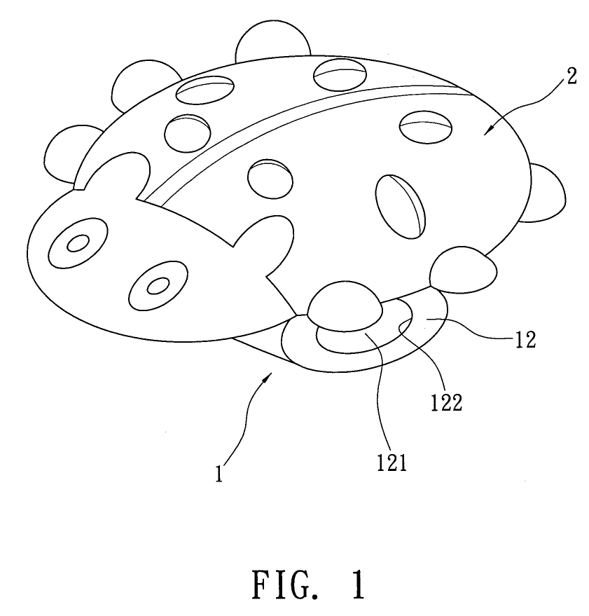

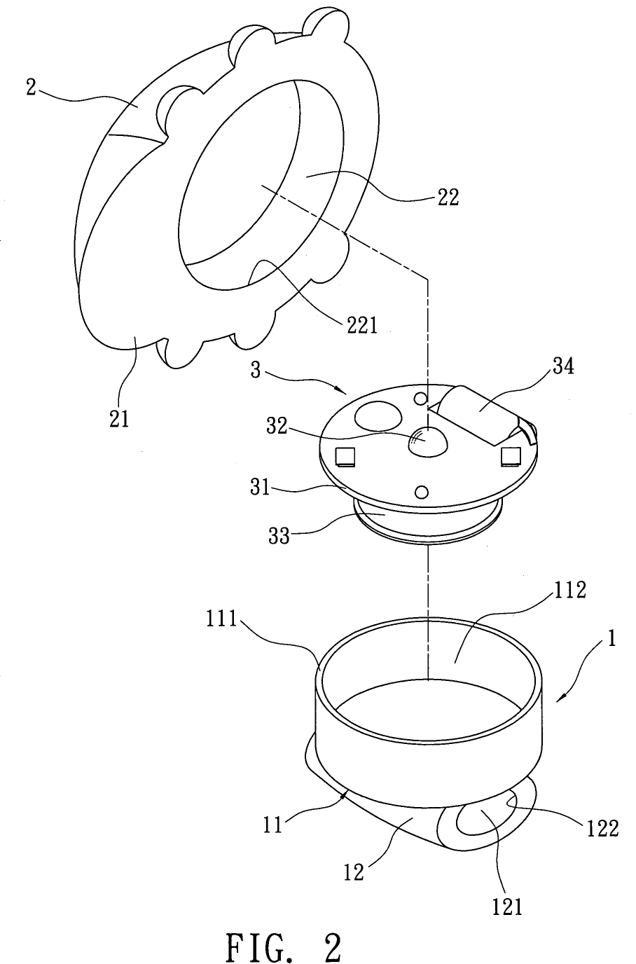

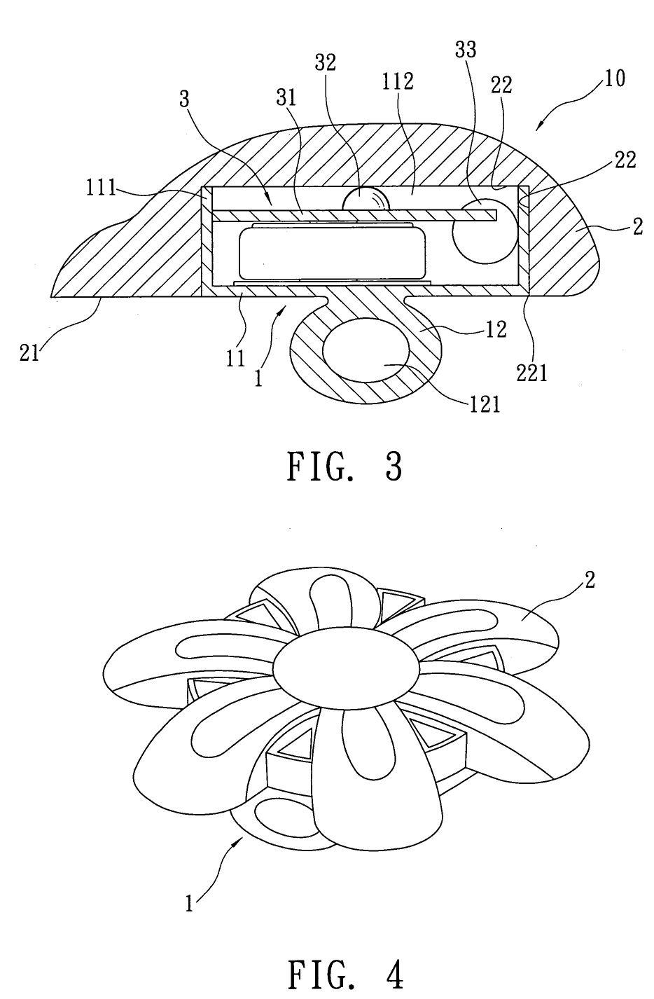

Referring to FIGS. 1 to 9 for an assembly of a decorative object in accordance with a preferred embodiment of the present invention, the embodiment is provided for illustration purpose only, and such structure is not intended to limit the scope of the present invention.

The invention provides a decorative object connectable to a connected object as shown in FIGS. 1 to 3, and the decorative object comprises a connecting member 1 connectable to the connected object, a stylish decorative object 2 fixed to the connecting member and a light emitting device 3 installed in the stylish decorative object 2.

The connecting member 1 includes a fixing portion 11 disposed on a side of the connecting member 1, and a positioning portion 12 on the other side of the connecting member 1, and the positioning portion 12 includes a passage 121 penetrating radially along the fixing portion 11, and the passage 121 forms an opening 122 separately on both ends of the positioning portion 12. In this embodiment, a circular wall surface 111 is extended upward from the periphery of the fixing portion 11 of the connecting member 1 to form a concave groove 112 in the wall surface 111, and the concave groove 112 is provided for installing the light emitting device 3 therein, and the positioning portion 12 is a pipe extended radially along the fixing portion 11, and the passage 121 is penetrated axially through the positioning portion 12.

The stylish decorative object 2 comes with a three-dimensional shape, and the stylish decorative object 2 includes a bottom surface 21, and the stylish decorative object 2 has a space 22 concavely disposed at the bottom surface 21 of the stylish decorative object 2, and the space 22 forms an opening 221 on the bottom surface 21 for embedding and fixing the wall surface 111 of the fixing portion 11 of the connecting member 1 from the opening 221 into the space 22, such that the light emitting device 3 is disposed in the stylish decorative object 2, and the stylish decorative object has a light transmission property for transmitting the light emitted by the light emitting device 3. In this embodiment, the stylish decorative object 2 has a shape of a ladybug. Of course, the stylish decorative object 2 can be in the shape of a strawberry, a mushroom, an apple or a flower as shown in FIG. 4 as well.

The light emitting device 3 includes a light emitting element 32 that emits light when the light emitting element 32 is vibrated, and at least one battery 33 is provided for supplying electric power to the light emitting element 32, and the light emitting element 32 is controlled by a vibration switch 34 to emit lights. In this embodiment, the light emitting element 32 is a light emitting diode, and the light emitting device 3 further comprises a circuit control board 31, and the circuit control board 31 installs the light emitting element 32, the battery 33 and the vibration switch 34, and the circuit control board 31 is contained in the concave groove 112 of the fixing portion 11 of the connecting member 1, such that the light emitting element 32 is disposed in the stylish decorative object 2.

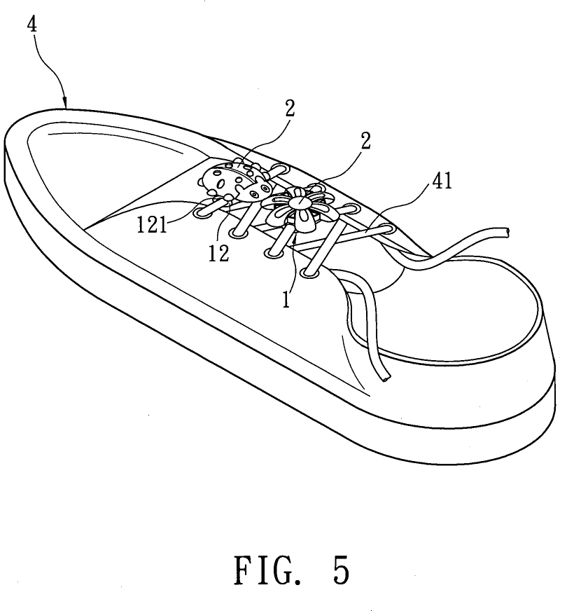

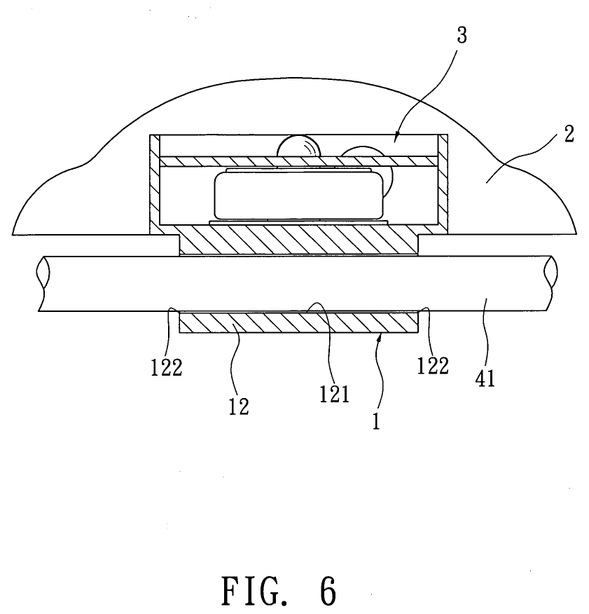

When use, the decorative object is connected to a connected object by using a connecting member 1 as shown in FIGS. 5 and 6. In this embodiment, a shoelace 41 of a shoe 4 is used as an example of the connected object for illustrating the invention. When the shoelace 41 is connected, the shoelace 41 is passed into the passage 121 from the opening 122 at an end of the positioning portion 12 of the connecting member 1 and then passed out from an opening 122 at another end of the passage 121, and tied onto the shoe 4, so that the connecting member 1 is connected to the shoelace 41, and the stylish decorative object 2 is disposed on an external side of the shoelace 41 of the shoe 4 for improving the decorative effect of the shoe 4.

In addition, more decorative objects in different shapes of the stylish decorative object can be prepared, so that users can connect their favorite decorative object to the shoelace to improve the decorative effect of the connected object. When a user walks, the light emitting device in the stylish decorative object will blink due to the vibration that triggers the vibration switch of the light emitting device to activate the light emitting element, so as to improve the decorative effect. Further, when users walk at nighttime, the light emitting device serves as a warning lamp to improve the practicability and fun of the decorative object.

If it is necessary to remove or replace the decorative object from the shoe, users simply need to separate the shoelace from the passage of the positioning portion of the connecting member, so that the decorative object can be removed or another decorative object of the stylish decorative object can be replaced.

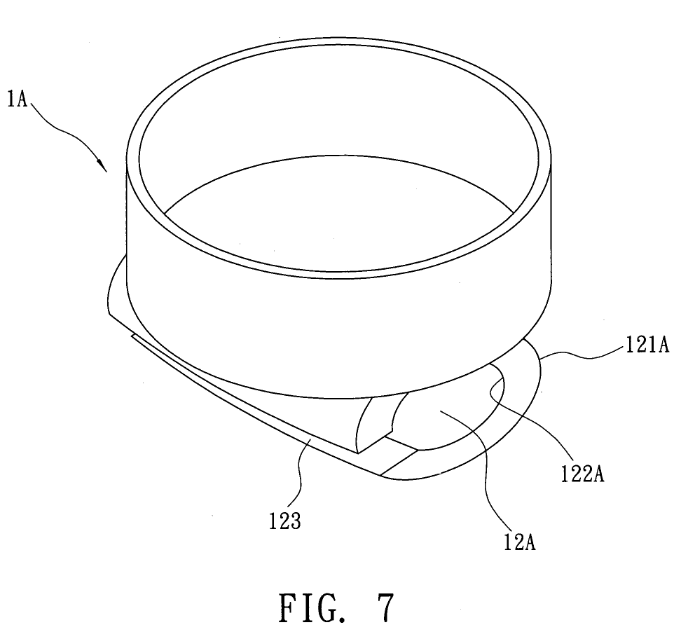

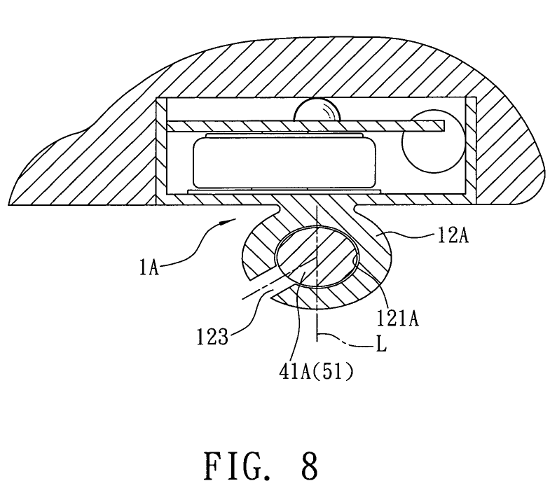

Referring to FIGS. 7 and 8 for a second preferred embodiment of the present invention, the connecting member 1A has a slot 123 disposed radially along the passage 121A of the positioning portion 12A, and extended to the openings 122A disposed separately on both ends of the positioning portion 12A. In this embodiment, the slot 123 is disposed and deviated from an axis L of the passage 121A. Therefore, the connected object in the form of a string or a strap can be stuffed into the passage 121A from the slot 123, such that the connecting member 1A can be connected onto the connected object.

Since the passage 121A has the slot 123 on a side of the passage 121A, therefore when the decorative object is connected to the shoelace 41A, the slot 123 can be used for stuffing the shoelace 41A directly into the passage 121A for the connection without removing the shoelace 41A, so that the decorative object can be installed and removed easily, and the slot 123 is installed and deviated from the axis L of the passage 121A, and thus the decorative object connected to the shoelace 41A will not fall off due to the up-and-down or back-and-forth vibrations caused by the user's walking or other activities.

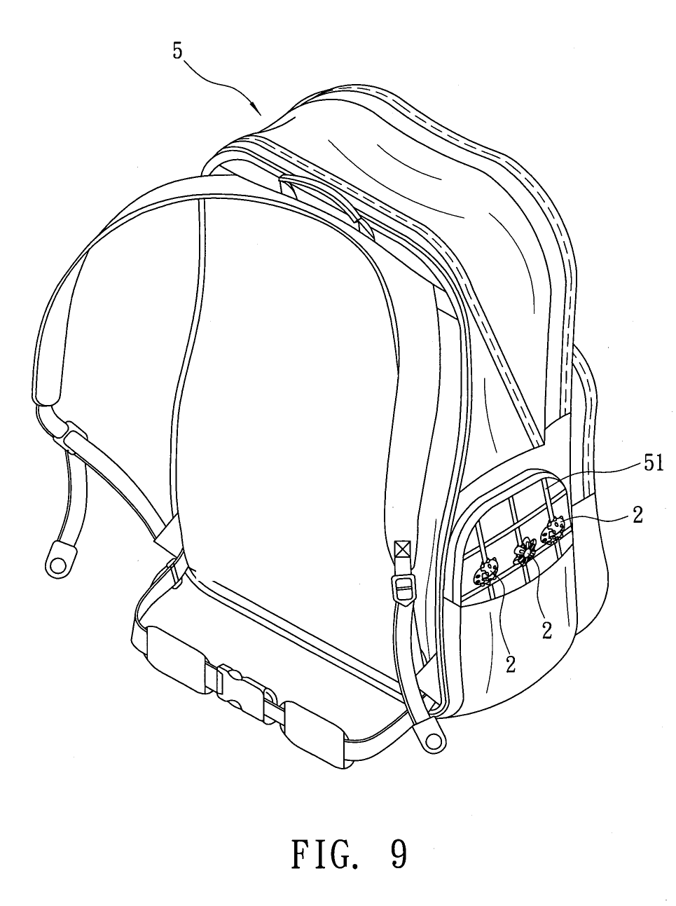

If the connected object in the form of a string or a strap cannot be removed as shown in FIGS. 8 and 9, or the connected object is a fixing string net 51 of a backpack 5, the slot 123 of the passage 121A can be used for connecting the fixing string net 51, since the fixing string net 51 is fixed onto the backpack 5, and the stylish decorative object 2 can be exposed from the backpack 5 to improve the decorative effect. In the meantime, if it is necessary to remove or replace the decorative object from the connected object, users simply need to separate the positioning portion of the connecting member from the fixing string net by using the slot, and the decorative object can be removed or an decorative object in another shape of the stylish decorative object can be replaced.

In summation of the description above, the present invention has the following advantages. With the structure of a positioning portion in accordance with the present invention, the decorative object can be connected to a connected object (in the form of a string or strap), and thus providing better divisibility and applicability of the decorative object. In addition, the design of the light emitting device not only gives more fun to its use, but also provides a warning lamp for users who walk at nighttime.

What is claimed is:

1. A decorative object connectable to a connected object, comprising a connecting member coupled to a connected object, a stylish decorative object fixed to the connecting member, and a light emitting element installed in the stylish decorative object, wherein:
the connecting member includes a fixing portion disposed on a side of the connecting member, and a positioning portion disposed on another side, and the positioning portion includes a passage penetrating radially along the fixing portion, and the passage forms an opening separately on both ends of the positioning portion;
the stylish decorative object comes with a three-dimensional shape, and is fixed to the fixing portion of the connecting member, and has a light transmissivity for transmitting light;
the light emitting device includes a light emitting element for emitting light when the light emitting device is vibrated, and at least one battery supplies electric power to the light emitting element, and the light emitting element is disposed in the stylish decorative object for transmitting the light emitted by the light emitting element.

2. The decorative object connectable to a connected object as recited in claim 1, wherein the positioning portion is a pipe extended radially along the fixing portion, and the passage is passed axially through the positioning portion.

3. The decorative object connectable to a connected object as recited in claim 2, wherein the passage has a slot disposed in a radial direction and extended to the openings respectively disposed on both ends of the slot.

4. The decorative object connectable to a connected object as recited in claim 3, wherein the slot is installed and deviated from the axis of the passage.

5. The decorative object connectable to a connected object as recited in claim 1, wherein the light emitting device further comprises a circuit control board, and the circuit control board installs the light emitting element, and the circuit control board installs the battery and a vibration switch, and the light emitting element emits light when the vibration switch is activated.

6. The decorative object connectable to a connected object as recited in claim 5, wherein the light emitting element of the light emitting device is a light emitting diode.

7. The decorative object connectable to a connected object as recited in claim 1, wherein the connecting member includes a wall surface extended upward from the periphery of the fixing portion of the connecting member, and the wall surface forms a concave groove therein for installing the light emitting device, and the stylish decorative object has a space therein for embedding the wall surface of the connecting member into the space, such that the light emitting element of the light emitting device is disposed in the stylish decorative object.

8. The decorative object connectable to a connected object as recited in claim 1, wherein the stylish decorative object has a shape of a ladybug.

9. The decorative object connectable to a connected object as recited in claim 1, wherein the stylish decorative object has a shape of a flower.
